(19) United States
(12) Patent Application Publication
(10) Pub. No.: US 2026/0094765 A1
(43) Pub. Date: Apr. 2, 2026

(54) MULTILAYER CERAMIC CAPACITOR

(71) Applicant: Murata Manufacturing Co., Ltd., Nagaokakyo-shi (JP)

(72) Inventor: Yuu MIKAMI, Nagaokakyo-shi (JP)

(21) Appl. No.: 19/311,402

(22) Filed: Aug. 27, 2025

(30) Foreign Application Priority Data
Sep. 27, 2024 (JP) 2024-168010

(51) Int. Cl. H01G 4/008; C04B 35/48; H01G 4/012; H01G 4/12; H01G 4/232; H01G 4/30

(52) U.S. Cl. CPC H01G 4/008; C04B 35/48; H01G 4/012; H01G 4/1236; H01G 4/232; H01G 4/30

(57) ABSTRACT

A multilayer ceramic capacitor includes a multilayer body including first and second external electrodes respectively on third and fourth surfaces thereof. A dimension of the multilayer body in a first direction is shorter than a dimension of the multilayer body in a second direction. The multilayer body includes first and second internal electrodes respectively exposed on the third and fourth surfaces, and inner dielectric layers. The inner dielectric layers include at least Ca, Sr or Zr, and Li as main components. Li segregation exists in at least one of the first and second external electrodes, and a size of Li segregation in the at least one of the first and second external electrodes is larger than a size of Li segregation in the inner dielectric layers.

### CROSS REFERENCE TO RELATED APPLICATIONS

This application claims the benefit of priority to Japanese Patent Application No. 2024-168010 filed on Sep. 27, 2024. The entire contents of this application are hereby incorporated herein by reference.

### BACKGROUND OF THE INVENTION

### 1. Field of the Invention

The present invention relates to multilayer ceramic capacitors.

### 2. Description of the Related Art

Multilayer ceramic capacitors used in electronic devices include multilayer ceramic capacitors having a high permittivity, and temperature compensation multilayer ceramic capacitors in which the change in capacitance is linear with respect to temperature change, as described in Japanese Unexamined Patent Application, Publication No. 2018-24542.

For example, the multilayer ceramic capacitor described in Japanese Unexamined Patent Application, Publication No. 2009-7209 uses copper or an alloy including copper for the internal electrodes and uses calcium zirconate as a main component for the dielectric layers. However, when copper is used for the internal electrodes, since its melting point is low, problems may arise in the step of sintering the dielectric in that the internal electrodes undergo excessive sintering, the effective areas of the internal electrodes decrease, and the capacitance decreases. Japanese Unexamined Patent Application, Publication No. 2009-7209 uses sintering aids such as lithium and silicon that form a liquid phase during firing in order to lower the temperature for sintering the dielectric to bring it as close as possible to the temperature of copper (also see Japanese Unexamined Patent Application, Publication No. 2019-62177, for example).

However, when segregated lithium (Li) is formed in the multilayer body during the firing step, lithium remains in the multilayer body, and the high-temperature load life of the multilayer ceramic capacitor may decrease.

### SUMMARY OF THE INVENTION

Example embodiments of the present invention provide multilayer ceramic capacitors that are each able to migrate lithium in the multilayer body to the external electrodes and improve the high-temperature load life.

A multilayer ceramic capacitor according to an example embodiment of the present invention includes a multilayer body including a first surface and a second surface opposed to each other in a lamination direction, a third surface and a fourth surface opposed to each other in a first direction orthogonal or substantially orthogonal to the lamination direction, and a fifth surface and a sixth surface opposed to each other in a second direction orthogonal or substantially orthogonal to the lamination direction and the first direction, a first external electrode on the third surface of the multilayer body, and a second external electrode on the fourth surface of the multilayer body. A dimension of the multilayer body in the first direction is shorter than a dimension of the multilayer body in the second direction. The multilayer body includes a plurality of first internal electrodes each including one end exposed on the third surface, a plurality of second internal electrodes each including one end exposed on the fourth surface, and a plurality of inner dielectric layers each including a corresponding one of the plurality of first internal electrodes or a corresponding one of the plurality of second internal electrodes provided therein. The plurality of inner dielectric layers each include at least Ca, Sr or Zr, and Li as main components. In at least one of a region of about 30 μm centered on a dimension of about ½ in the lamination direction and an interface between the multilayer body and the first external electrode or a region of about 30 μm centered on a dimension of about ½ in the lamination direction and an interface between the multilayer body and the second external electrode, Li segregation exists in at least one of the first external electrode and the second external electrode, and a size of the Li segregation in the at least one of the first external electrode and the second external electrode is larger than a size of Li segregation in the plurality of inner dielectric layers.

According to a multilayer ceramic capacitor of an example embodiment of the present invention, the dimension of the multilayer body in the first direction is shorter than the dimension of the multilayer body in the second direction, the plurality of inner dielectric layers each include at least Ca, Sr or Zr, and Li as main components, and in at least one of a region of about 30 μm centered on a dimension of about ½ in the lamination direction and an interface between the multilayer body and the first external electrode and a region of about 30 μm centered on a dimension of about ½ in the lamination direction and an interface between the multilayer body and the second external electrode, Li segregation exists in at least one of the first external electrode and the second external electrode, and a size of the Li segregation in the at least one of the first external electrode and the second external electrode is larger than a size of the Li segregation in the plurality of inner dielectric layers, such that it is possible to improve high-temperature load reliability.

According to example embodiments of the present multilayer ceramic capacitors that are each able to move lithium in the multilayer body to the external electrodes and improve the high-temperature load life are provided.

The foregoing and other elements, features and advantages of example embodiments of the present invention will be more fully apparent from the following description of example embodiments with reference to the drawings.

### BRIEF DESCRIPTION OF THE DRAWINGS

FIG. 1 is an external perspective view showing an example of a multilayer ceramic capacitor according to an example embodiment of the present invention.

FIG. 2 is a cross-sectional view taken along the line II-II of FIG. 1.

FIG. 3 is a cross-sectional view taken along the line III-III of FIG. 1.

FIG. 4 is a cross-sectional view taken along the line IV-IV of FIG. 1.

FIG. 5 is an external perspective view showing an example of a multilayer ceramic capacitor according to modified example 1 of an example embodiment of the present invention.

FIG. 6 is a cross-sectional view taken along the line VI-VI of FIG. 5.

FIG. 7 is a cross-sectional view taken along the line VII-VII of FIG. 5.

FIG. 8 is a cross-sectional view taken along the line VIII-VIII of FIG. 5.

FIG. 9 is an external perspective view showing an example of a multilayer ceramic capacitor according to modified example 2 of an example embodiment of the present invention.

FIG. 10 is a cross-sectional view taken along the line X-X of FIG. 9.

FIG. 11 is a cross-sectional view taken along the line XI-XI of FIG. 9.

FIG. 12 is a cross-sectional view taken along the line XII-XII of FIG. 9.

FIG. 13 is a cross-sectional view showing modified example 3 of an example embodiment of the present invention in the cross-sectional view shown in FIG. 10.

### DETAILED DESCRIPTION OF THE EXAMPLE EMBODIMENTS

Example embodiments of the present invention will be described in detail below with reference to the drawings.

### 1. Multilayer Ceramic Capacitor

A multilayer ceramic capacitor according to an example embodiment of the present invention will be described.

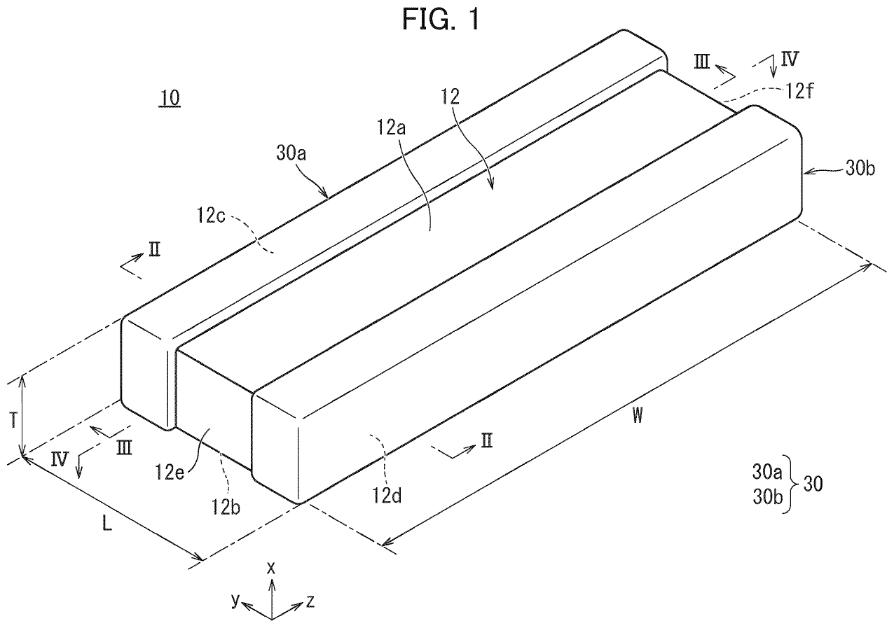

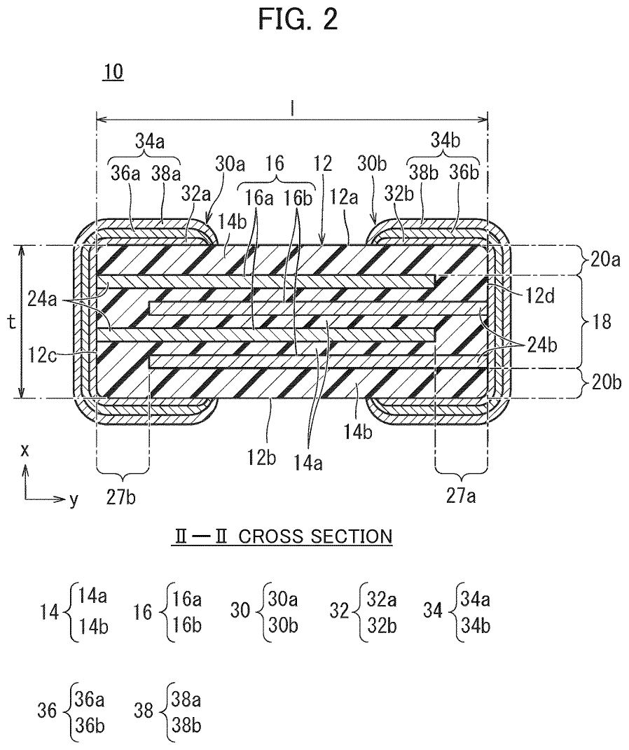

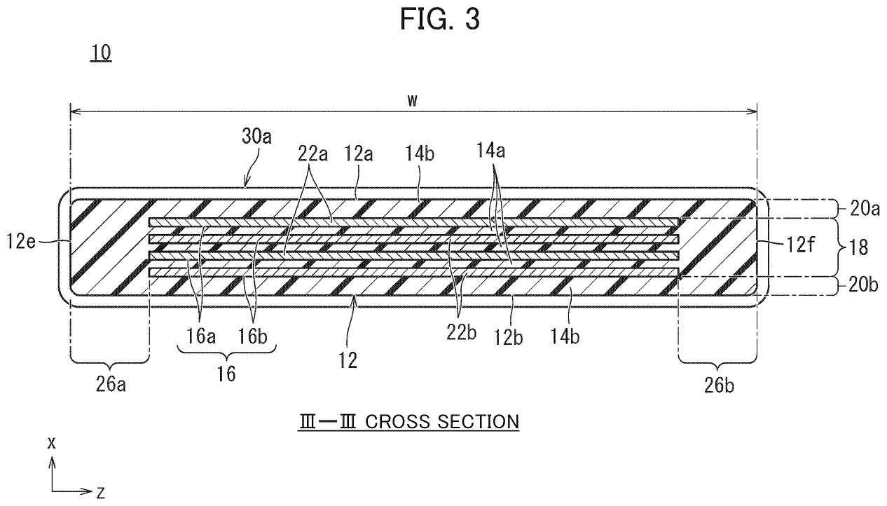

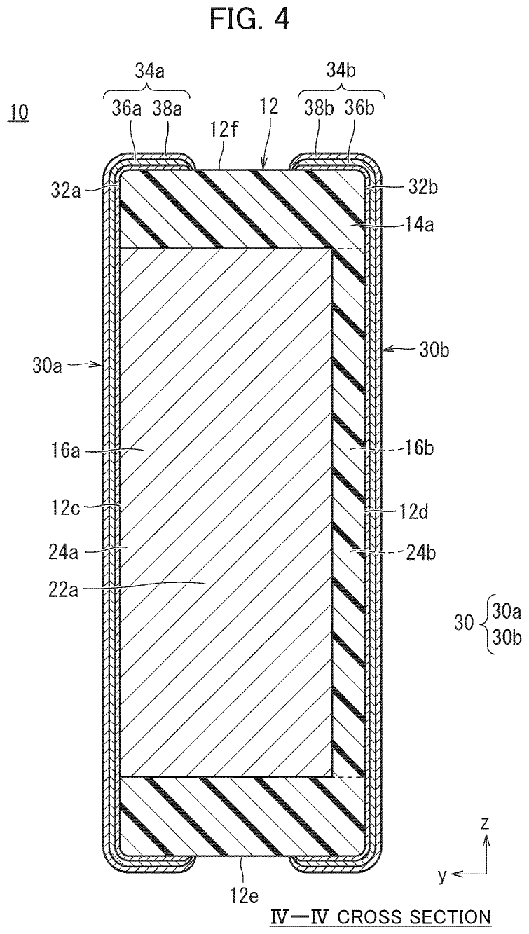

FIG. 1 is an external perspective view showing an example of a multilayer ceramic capacitor according to an example embodiment of the present invention. FIG. 2 is a cross-sectional view taken along the line II-II of FIG. 1. FIG. 3 is a cross-sectional view taken along the line III-III of FIG. 1. FIG. 4 is a cross-sectional view taken along the line IV-IV of FIG. 1.

As shown in FIGS. 1 to 3, the multilayer ceramic capacitor 10 includes a rectangular or substantially rectangular parallelepiped multilayer body 12 and external electrodes 30 provided at both end portions of the multilayer body 12.

### Multilayer Body

The multilayer body 12 includes a plurality of dielectric layers 14 that are laminated and a plurality of internal electrodes 16 that are laminated respectively on the dielectric layers 14. Further, the multilayer body 12 includes a first surface 12a and a second surface 12b opposed to each other in the lamination direction x, a third surface 12c and a fourth surface 12d opposed to each other in the first direction y orthogonal or substantially orthogonal to the lamination direction x, and a fifth surface 12e and a sixth surface 12f opposed to each other in the second direction z orthogonal or substantially orthogonal to the lamination direction x and the first direction y.

The first surface 12a and the second surface 12b, or one of the surfaces is preferably flat. If it is flat, it is possible to disperse the stress received from a nozzle that picks up the multilayer ceramic capacitor 10 on the flat surface. As a result, it is possible to improve the strength of the multilayer ceramic capacitor during mounting.

Also, the surface of the multilayer body 12 may be roughened.

The multilayer body 12 may include rounded corner portions and rounded ridge portions. Each of the portions where two surfaces among the first surface 12a, the second surface 12b, the third surface 12c, the fourth surface 12d, the fifth surface 12e, and the sixth surface 12f intersect is referred to as a ridge portion, and each of the portions where three surfaces intersect is referred to as a corner portion. The ridge portions and corner portions are each preferably rounded with a radius R. By providing the ridge portions and corner portions each with a radius R, it is possible to prevent chipping and cracking. When the ridge portions and corner portions are each provided with a radius R, the main surfaces may be flat for surfaces excluding the ridge portions and corner portions.

Here, the dimension of the multilayer body 12 in the first direction y is defined as the 1 dimension, the dimension of the multilayer body 12 in the second direction z is defined as the w dimension, and the dimension of the multilayer body 12 in the lamination direction x is defined as the t dimension. The dimension 1 of the multilayer body 12 in the first direction y is shorter than the dimension w of the multilayer body 12 in the second direction z. This makes it possible to shorten the current path, and thus it is possible to reduce the ESL of the multilayer ceramic capacitor 10.

As shown in FIGS. 2 and 3, the multilayer body 12 includes an inner layer portion 18 in which dielectric layers 14 and internal electrodes 16 are alternately laminated in the lamination direction x connecting the first surface 12a and the second surface 12b, a first surface-side outer layer portion 20a including a plurality of dielectric layers 14 provided between an internal electrode 16 located closest to the first surface 12a and the first surface 12a, and a second surface-side outer layer portion 20b including a plurality of dielectric layers 14 provided between an internal electrode 16 located closest to the second surface 12b and the second surface 12b.

### Inner Layer Portion

The inner layer portion 18 includes a plurality of inner dielectric layers 14a among the plurality of dielectric layers 14. That is, the inner layer portion 18 is provided such that a plurality of internal electrodes 16 are opposed to each other with the inner dielectric layers 14a interposed therebetween.

The inner dielectric layers 14a include, as main components, at least Ca, Sr or Zr, and Li. For example, the inner dielectric layers 14a include CaZrO₃ or SrZrO₃ as a dielectric component and include Li as a sintering aid. In addition to these, the inner dielectric layers 14a may include, for example, Mn, Ti, or other components.

The main components of the inner dielectric layers 14a can be observed as follows. That is, a cross section in the lamination direction x×the first direction y is exposed when the multilayer ceramic capacitor 10 is polished in the second direction z to about ½ of the W dimension in the second direction z. Then, the exposed cross section is observed using TOF.SIM (available from ION-TOF) under conditions of about 30 μm.

As shown in FIGS. 2 and 3, the internal electrodes 16 include first internal electrodes 16a and second internal electrodes 16b. The first internal electrodes 16a and the second internal electrodes 16b are alternately laminated with the inner dielectric layers 14a interposed therebetween.

The first internal electrodes 16a are each provided on a corresponding one of the plurality of dielectric layers 14 and are located inside the multilayer body 12. The first internal electrodes 16a each include a first counter electrode portion 22a opposed to a corresponding one of the second internal electrodes 16b, and a first extension electrode portion 24a that is located adjacent to one end of the first internal electrode 16a and extends from the first counter electrode portion 22a toward the third surface 12c of the multilayer body 12. The first extension electrode portion 24a includes an end portion extending toward the surface of the third surface 12c and exposed from the multilayer body 12. That is, the end portion of the first extension electrode portion 24a is not exposed at the first surface 12a and the second surface 12b, the fourth surface 12d, and the fifth surface 12e and the sixth surface 12f. Specifically, the end portion of the first internal electrode 16a is slightly recessed from the fourth surface 12d.

The shape of each of the first counter electrode portions 22a of the first internal electrodes 16a is not particularly limited, but is, for example, preferably rectangular or substantially rectangular in a plan view. The first counter electrode portion 22a may have rounded corner portions or obliquely shaped (tapered) corner portions in a plan view. Further, the first counter electrode portion 22a may also be sloped and tapered in either direction in a plan view.

The shape of each of the first extension electrode portions 24a of the first internal electrodes 16a is not particularly limited, but is, for example, preferably rectangular or substantially rectangular in a plan view. The first extension electrode portion 24a may have rounded corner portions or obliquely shaped (tapered) corner portions in a plan view. Further, the first extension electrode portion 24a may also be sloped and tapered in either direction in a plan view.

The width of each of the first counter electrode portions 22a of the first internal electrodes 16a and the width of each of the first extension electrode portions 24a of the first internal electrodes 16a may have the same or substantially the same width, or the width of either one may be narrower.

The second internal electrodes 16b are each provided on a corresponding one of the plurality of dielectric layers 14 and are located inside the multilayer body 12. The second internal electrodes 16b each include a second counter electrode portion 22b opposed to a corresponding one of the first internal electrode 16a, and a second extension electrode portion 24b that is located adjacent to one end of the second internal electrode 16b and extends from the second counter electrode portion 22b toward the fourth surface 12d of the multilayer body 12. The second extension electrode portion 24b includes an end portion extending toward the surface of the fourth surface 12d and exposed from the multilayer body 12. That is, the end portion of the second extension electrode portion 24b is not exposed at the first surface 12a and the second surface 12b, the third surface 12c, and the fifth surface 12e and the sixth surface 12f. Specifically, the end portion of the second internal electrode 16b is slightly recessed from the third surface 12c.

The shape of each of the second counter electrode portions 22b of the second internal electrodes 16b is not particularly limited, but is, for example, preferably rectangular or substantially rectangular in a plan view. The second counter electrode portions 22b may have rounded corner portions or obliquely shaped (tapered) corner portions in a plan view. Further, the second counter electrode portions 22b may also be sloped and tapered in either direction in a plan view.

The shape of each of the second extension electrode portions 24b of the second internal electrode 16b is not particularly limited, but is, for example, preferably rectangular or substantially rectangular in a plan view. The second extension electrode portions 24b may have rounded corner portions or obliquely shaped (tapered) corner portions in a plan view. Further, the second extension electrode portions 24b may also be sloped and tapered in either direction in a plan view.

The width of each of the second counter electrode portions 22b of the second internal electrodes 16b and the width of each of the second extension electrode portions 24b of the second internal electrodes 16b may have the same or substantially the same width, or the width of either one may be narrower.

As shown in FIG. 3, the multilayer body 12 includes a lateral portion 26a of the multilayer body 12 provided between one end of each of the first counter electrode portions 22a and the second counter electrode portions 22b in the second direction z and the fifth surface 12e, and a lateral portion 26b of the multilayer body 12 provided between the other end of each of the first counter electrode portions 22a and the second counter electrode portions 22b in the second direction z and the sixth surface 12f.

As shown in FIG. 2, the multilayer body 12 includes an end portion 27a of the multilayer body 12 provided between the end portion opposite to the first extension electrode portions 24a of the first internal electrodes 16a and the fourth surface 12d, and an end portion 27b of the multilayer body 12 provided between the end portion opposite to the second extension electrode portion 24b of the second internal electrode 16b and the third surface 12c.

Each of the internal electrodes 16 includes, for example, Cu as a main component. Thus, it is possible to reduce the electrical resistance of the internal electrodes 16 and reduce the ESR. In addition, by using Cu as the main component of the internal electrode 16, it is possible to provide the internal electrodes 16 using an inexpensive material.

The main component of the internal electrodes 16 can be observed as follows. That is, a cross section in the lamination direction x×first direction y is exposed when the multilayer ceramic capacitor 10 is polished in the second direction z to about ½ of the W dimension in the second direction z. Then, the exposed cross section is observed using TOF.SIM (available from ION-TOF) under conditions of about 30 μm.

The thickness of each of the internal electrodes 16 is, for example, preferably about 0.5 μm or more and about 3.5 μm or less. The total number of the first internal electrodes 16a and the second internal electrodes 16b is, for example, preferably two or more and thirty or less.

### First Surface-Side Outer Layer Portion, Second Surface-Side Outer Layer Portion

The first surface-side outer layer portion 20a is located adjacent to the first surface 12a of the multilayer body 12, and is an aggregate of a plurality of outer layer dielectric layers 14b, which are a plurality of dielectric layers 14 located between the first surface 12a and an internal electrode 16 closest to the first surface 12a. The second surface-side outer layer portion 20b is located adjacent to the second surface 12b of the multilayer body 12, and is an aggregate of a plurality of outer layer dielectric layers 14b, which are a plurality of dielectric layers 14 located between the second surface 12b and an internal electrode 16 closest to the second surface 12b. The region sandwiched between the first surface-side outer layer portion 20a and the second surface-side outer layer portion 20b corresponds to the inner layer portion 18.

The first surface-side outer layer portion 20a and the second surface-side outer layer portion 20b are each made of an insulating material. When the first surface-side outer layer portion 20a and the second surface-side outer layer portion 20b are made of the same or substantially the same type of dielectric material as the inner dielectric layers 14a, each of the outer layer portions 20a and 20b may include a plurality of outer layer dielectric layers 14b or may include a single outer layer dielectric layer 14b.

### External Electrode

As shown in FIGS. 1 to 3, the external electrodes 30 are respectively provided adjacent to the third surface 12c and the fourth surface 12d of the multilayer body 12.

The external electrodes 30 each include a base electrode layer 32 including a metal component and glass, and a plated layer 34 provided on a surface of the base electrode layer 32.

The external electrodes 30 include a first external electrode 30a and a second external electrode 30b.

The first external electrode 30a is connected to the first internal electrodes 16a and is provided on at least a portion of the third surface 12c. Further, the first external electrode 30a preferably extends from the third surface 12c of the multilayer body 12 to a portion of the first surface 12a and a portion of the second surface 12b, and a portion of the fifth surface 12e and a portion of the sixth surface 12f. The first external electrode 30a is electrically connected to the first extension electrode portions 24a of the first internal electrodes 16a.

The second external electrode 30b is connected to the second internal electrodes 16b and is provided on at least a surface of the fourth surface 12d. Further, the second external electrode 30b preferably extends from the fourth surface 12d of the multilayer body 12 to a portion of the first surface 12a and a portion of the second surface 12b, and a portion of the fifth surface 12e and a portion of the sixth surface 12f. The second external electrode 30b is electrically connected to the second extension electrode portions 24b of the second internal electrodes 16b.

In the multilayer body 12, capacitance is generated between the first counter electrode portions 22a of the first internal electrodes 16a and the second counter electrode portions 22b of the second internal electrodes 16b, which are opposed to each other with a corresponding one of the dielectric layers 14 in between them. Therefore, capacitance is generated between the first external electrode 30a connected to the first internal electrodes 16a and the second external electrode 30b connected to the second internal electrodes 16b to provide capacitor characteristics.

The base electrode layer 32 includes a first base electrode layer 32a and a second base electrode layer 32b.

The first base electrode layer 32a is connected to the first internal electrodes 16a and is provided on a surface of the third surface 12c. Further, the first base electrode layer 32a preferably extends from the third surface 12c to a portion of the first surface 12a and a portion of the second surface 12b, and a portion of the fifth surface 12e and a portion of the sixth surface 12f. The first base electrode layer 32a is electrically connected to the first extension electrode portions 24a of the first internal electrodes 16a.

The second base electrode layer 32b is connected to the second internal electrodes 16b and is provided on a surface of the fourth surface 12d. Further, the second base electrode layer 32b preferably extends from the fourth surface 12d to a portion of the first surface 12a and a portion of the second surface 12b, and a portion of the fifth surface 12e and a portion of the sixth surface 12f. The second base electrode layer 32b is electrically connected to the second extension electrode portions 24b of the second internal electrodes 16b.

The base electrode layer 32 includes, for example, Cu as a main component. The base electrode layer 32 includes a glass component in addition to Cu as the main component. The base electrode layer 32 includes Cu having low specific resistance as the main component, such that it is possible to reduce the ESR of the multilayer ceramic capacitor 10. Further, the base electrode layer 32 includes the glass component, such that it is possible to improve the sinterability of the base electrode layer 32. The glass component may include, for example, Na, B, Si, Zn, Ba, or the like.

In the present example embodiment, as the Cu diameter is reduced, the interfaces of the Cu particles increase, resulting in higher ESR. For this reason, for example, the particle size D50 of the Cu particles of the Cu included in the base electrode layer 32 is preferably about 1.5 μm or more and about 3.5 μm or less.

The base electrode layer 32 includes Li segregation in a region of about 30 μm centered on about ½ in the lamination direction x and the interface between the multilayer body 12 and the external electrode 30, and the Li segregation of the base electrode layer 32 is larger than the Li segregation included in the inner dielectric layer 14a. In the region of about 30 μm centered on about ½ in the lamination direction x and the interface between the multilayer body 12 and the external electrode 30, the size of the Li segregation is, for example, preferably about 1.0 μm² or more and about 30.2 μm² or less.

The size of the Li segregation in the base electrode layer 32 is defined by the presence of Li when the base electrode layer 32 located in the middle of the lamination direction x is observed using TOF.SIMS under conditions of about 30 μm with the interface between the multilayer body 12 and the base electrode layer 32 as the center of the observed image, in a cross section in the lamination direction x×the first direction y when the multilayer ceramic capacitor 10 is polished to about ½ of the W direction in the second direction z.

The size of the Li segregation in the base electrode layer 32 and the size of the Li segregation in the inner dielectric layer 14a can be measured by TOF.SIMS (Time-of-Flight Secondary Ion Mass Spectrometry). The measurement conditions by this TOF.SIMS are as follows.
Device name: TOF.SIMS (available from ION-TOF)
Primary ion: Bi⁺
Acceleration voltage: about 25 kV
Secondary ion polarity: Positive
Number of scans: 32
Number of pixels: 256 pixels×256 pixels
Measurement area: about 30 μm×about 30 μm

For the size of Li segregation, pixels with Li intensity of about 1.0 or more among the 256 pixels×256 pixels are counted as Li. For the size of Li segregation, those with an area of about 0.50 μm² or more are counted as Li. For example, when there are three Li segregations, the one with the largest size among them is defined as one having the size of Li.

The thickness in the first direction y connecting the third surface 12c and the fourth surface 12d in the middle portion in the lamination direction x of the first base electrode layer 32a located on the third surface 12c is preferably, for example, about 19 μm or more and about 24 μm or less.

The thickness in the first direction y connecting the third surface 12c and the fourth surface 12d in the middle portion in the lamination direction x of the second base electrode layer 32b located on the fourth surface 12d is preferably, for example, about 19 μm or more and about 24 μm or less.

Next, the first plated layer 34a and the second plated layer 34b, which are the plated layers 34 provided on the base electrode layer 32, are described with reference to FIG. 2 and FIG. 3.

The first plated layer 34a and the second plated layer 34b each include at least one of, for example, Cu, Ni, Sn, Ag, Pd, Ag—Pd alloy, Au, or the like.

The first plated layer 34a completely covers the first base electrode layer 32a. The second plated layer 34b completely covers the second base electrode layer 32b.

The first plated layer 34a and the second plated layer 34b may include a plurality of layers. In this case, for example, the plated layer 34 preferably includes a two-layer configuration including a lower plated layer (Ni plated layer) formed by Ni plating on the base electrode layer 32 and an upper plated layer (Sn plated layer) formed by Sn plating on the lower plated layer. That is, in this case, the first plated layer 34a includes a first lower plated layer 36a and a first upper plated layer 38a located on the surface of the first lower plated layer 36a. The second plated layer 34b includes a second lower plated layer 36b and a second upper plated layer 38b located on the surface of the second lower plated layer 36b.

The lower plated layer 36 by Ni plating is used in order to prevent the base electrode layer 32 from being eroded by solder when mounting the multilayer ceramic capacitor 10, and the upper plated layer 38 by Sn plating is used in order to improve the wettability of solder when mounting the multilayer ceramic capacitor 10 and to enable easy mounting. The thickness of each of the lower plated layer 36 and the upper plated layer 38 per single layer is preferably about 1.0 μm or more and about 15.0 μm or less.

A dimension in the first direction y of the multilayer ceramic capacitor 10 including the multilayer body 12, the first external electrode 30a, and the second external electrode 30b is defined as an L dimension, a dimension in the lamination direction x of the multilayer ceramic capacitor 10 including the multilayer body 12, the first external electrode 30a, and the second external electrode 30b is defined as a T dimension, and a dimension in the second direction z of the multilayer ceramic capacitor 10 including the multilayer body 12, the first external electrode 30a, and the second external electrode 30b is defined as a W dimension. Regarding the dimensions of the multilayer ceramic capacitor 10, for example, the L dimension in the first direction y is about 0.2 mm or more and about 0.5 mm or less, the W dimension in the second direction z is about 0.4 mm or more and about 1.0 mm or less, and the T dimension in the lamination direction x is about 0.15 mm or more and about 0.35 mm or less. The dimensions of the multilayer ceramic capacitor 10 can be measured by a microscope, for example.

In the multilayer ceramic capacitor 10 shown in FIG. 1, the dimension 1 in the first direction y of the multilayer body 12 is shorter than the dimension w in the second direction z of the multilayer body 12, each of the inner dielectric layers 14a of the multilayer body 12 includes, for example, as main components, at least Ca, Sr or Zr, and Li, and in a region of about 30 μm centered on about ½ in the lamination direction x and the interface between the multilayer body 12 and the external electrode 30, the base electrode layer 32 includes Li segregation, and the Li segregation of the base electrode layer 32 is larger than the Li segregation included in the inner dielectric layer, such that it is possible to improve high-temperature reliability.

Furthermore, in the multilayer ceramic capacitor 10 shown in FIG. 1, when the size of the Li segregation is 1.0 μm² or more and 30.2 μm² or less in the region of about 30 μm centered on about ½ in the lamination direction x and the interface between the multilayer body 12 and the external electrode 30, it is possible to further improve high-temperature reliability.

### 2. Modified Examples

### (1) Modified Example 1

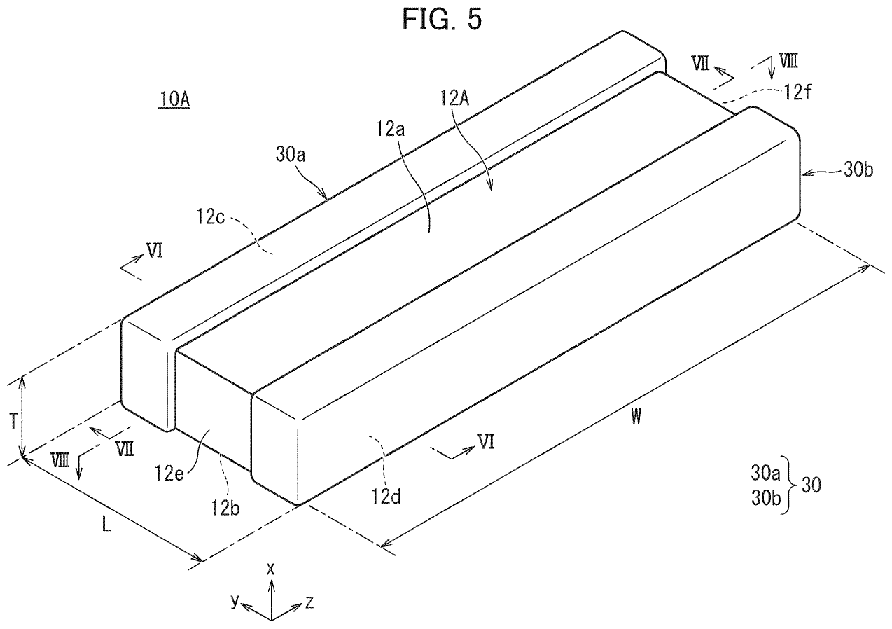

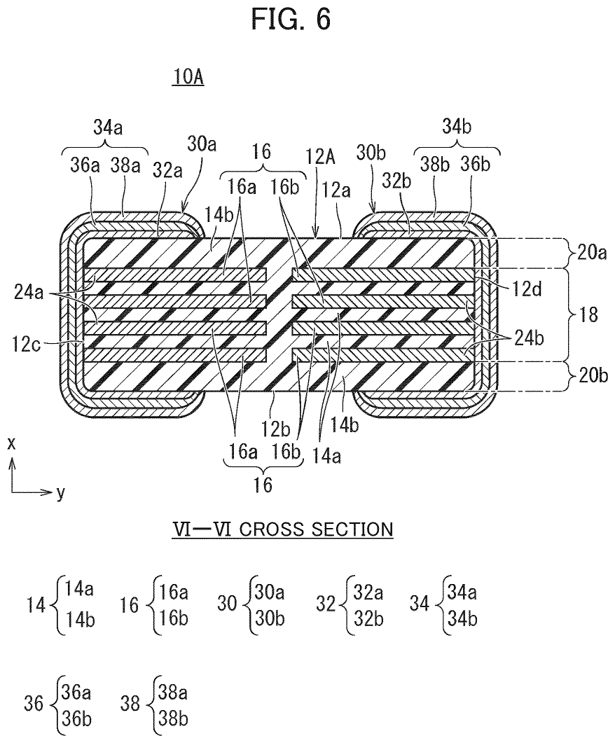

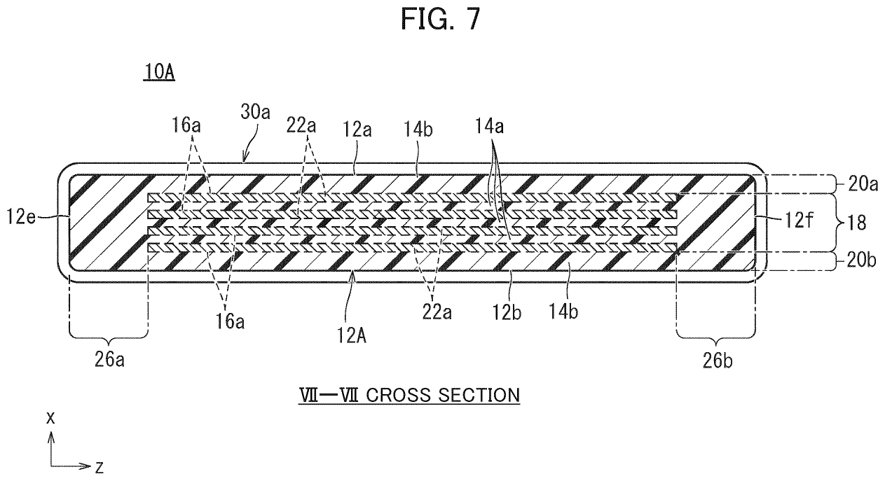

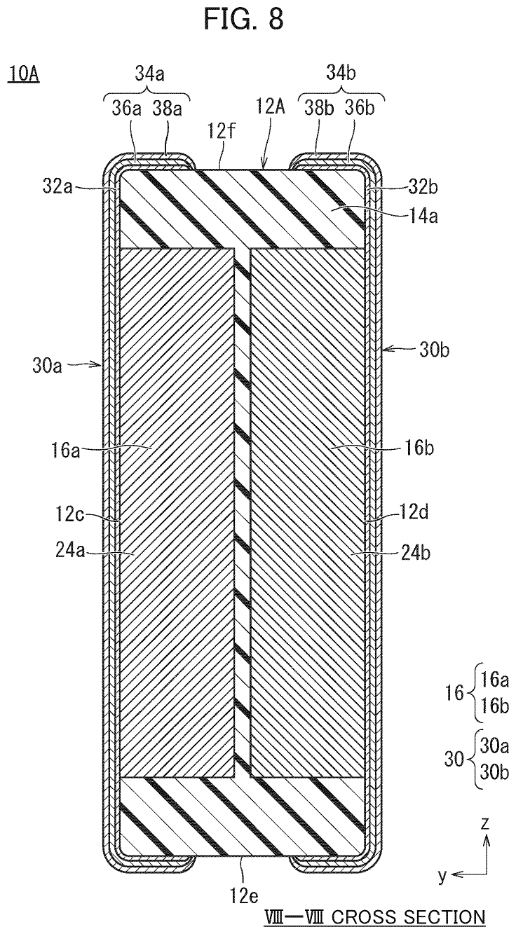

Next, an example of a multilayer ceramic capacitor 10A according to modified example 1 of an example embodiment will be described. FIG. 5 is an external perspective view showing an example of a multilayer ceramic capacitor according to the modified example 1 of the example embodiment of the present invention. FIG. 6 is a cross-sectional view taken along the line VI-VI of FIG. 5. FIG. 7 is a cross-sectional view taken along the line VII-VII of FIG. 5. FIG. 8 is a cross-sectional view taken along the line VIII-VIII of FIG. 5. However, the same or corresponding configurations as those in FIGS. 1 to 4 are assigned the same reference numerals, and detailed descriptions thereof are omitted.

The multilayer ceramic capacitor 10A according to the modified example 1 of the present example embodiment includes a rectangular or substantially rectangular parallelepiped multilayer body 12A and external electrodes 30 provided at both ends of the multilayer body 12A.

The multilayer body 12A includes a plurality of laminated dielectric layers 14. Furthermore, the multilayer body 12A includes a first surface 12a and a second surface 12b opposed to each other in the lamination direction x, a third surface 12c and a fourth surface 12d opposed to each other in the first direction y orthogonal or substantially orthogonal to the lamination direction x, and a fifth surface 12e and a sixth surface 12f opposed to each other in the second direction z orthogonal or substantially orthogonal to the lamination direction x and the first direction y.

In the multilayer body 12A, as shown in FIGS. 6 and 8, first internal electrodes 16a and second internal electrodes 16b are provided in the inner layer portion 18. Further, each of the first internal electrodes 16a and an associated one of the second internal electrodes 16b are provided on the same one of the inner dielectric layers 14a with a predetermined interval therebetween. In other words, the first internal electrode 16a and the second internal electrode 16b are opposed to each other in the first direction y.

According to the multilayer ceramic capacitor 10A according to the modified example 1 shown in FIG. 5, it is possible to achieve the same or substantially the same advantageous effects as those of the multilayer ceramic capacitor 10 of FIG. 1.

### (2) Modified Example 2

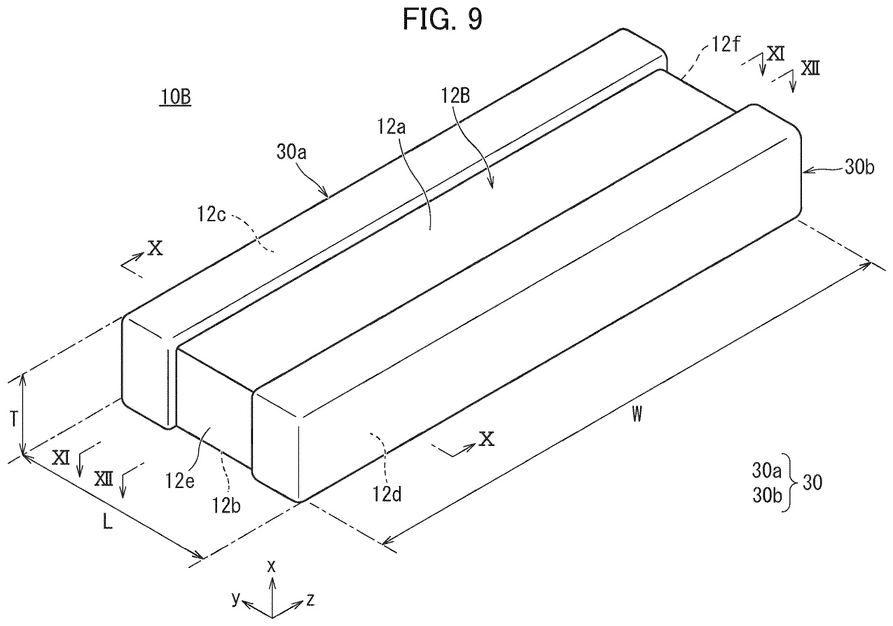

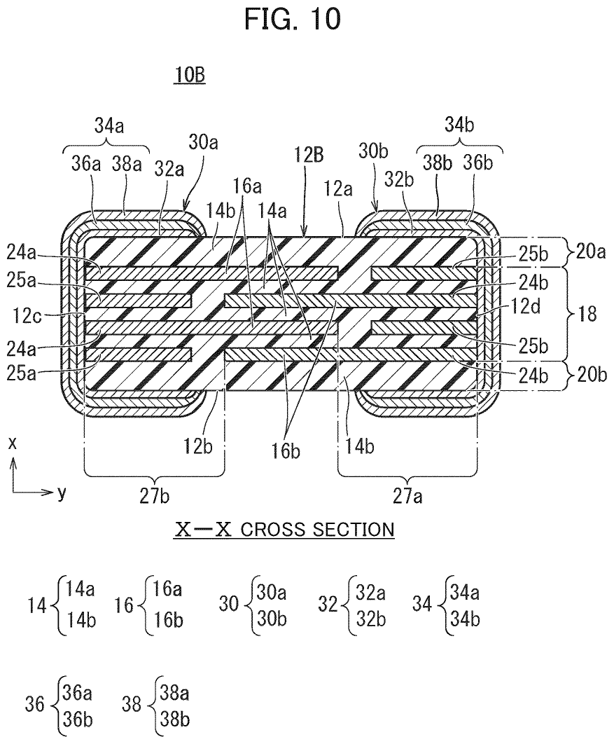

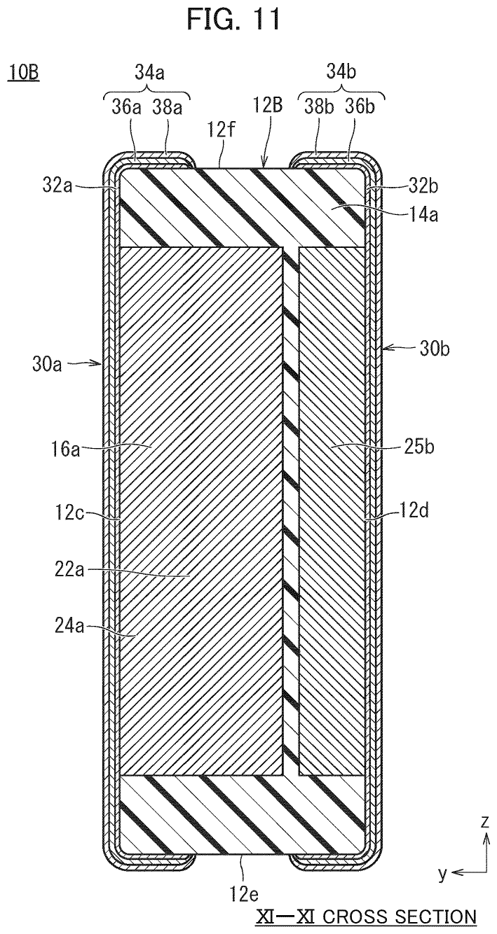

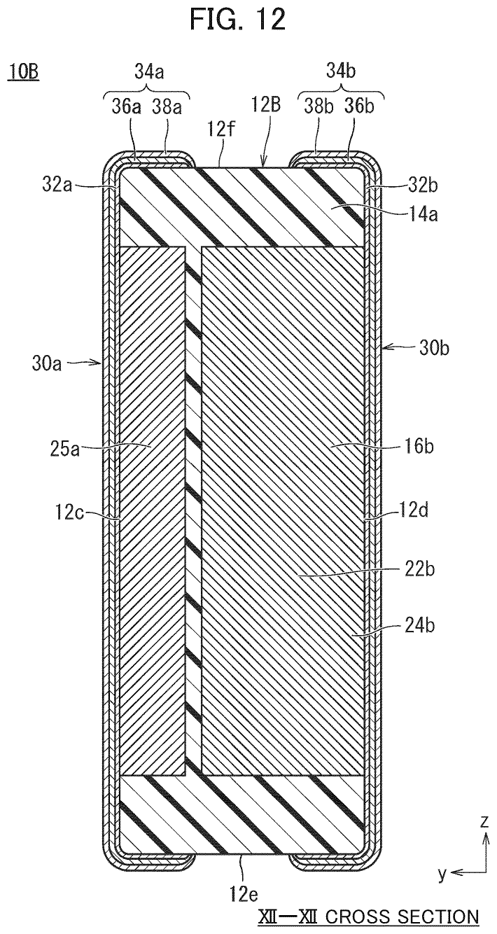

Next, an example of a multilayer ceramic capacitor 10B according to modified example 2 of an example embodiment of the present invention will be described. FIG. 9 is an external perspective view showing an example of a multilayer ceramic capacitor according to the modified example 2 of the example embodiment of the present invention. FIG. 10 is a cross-sectional view taken along the line X-X of FIG. 9. FIG. 11 is a cross-sectional view taken along the line XI-XI of FIG. 9. FIG. 12 is a cross-sectional view taken along the line XII-XII of FIG. 9. However, the same or corresponding configurations as those in FIGS. 1 to 4 are assigned the same reference numerals, and detailed descriptions thereof are omitted.

The multilayer ceramic capacitor 10B according to the modified example 2 of the present example embodiment includes a rectangular or substantially rectangular parallelepiped-shaped multilayer body 12B and external electrodes 30 provided at both ends of the multilayer body 12B.

The multilayer body 12B includes a plurality of laminated dielectric layers 14. Further, the multilayer body 12B includes a first surface 12a and a second surface 12b opposed to each other in the lamination direction x, a third surface 12c and a fourth surface 12d opposed to each other in the first direction y orthogonal or substantially orthogonal to the lamination direction x, and a fifth surface 12e and a sixth surface 12f opposed to each other in the second direction z orthogonal or substantially orthogonal to the lamination direction x and the first direction y.

As shown in FIGS. 10 to 12, the multilayer body 12B includes, as internal electrodes 16, first internal electrodes 16a and second internal electrodes 16b.

The first internal electrodes 16a are electrically connected to the first external electrode 30a. The second internal electrodes 16b are electrically connected to the second external electrode 30b.

Further, first dummy electrodes 25a are provided in the end portion (L gap) 27b of the multilayer body 12B so as to be exposed at the third surface 12c. Further, second dummy electrodes 25b are provided in the end portion (L gap) 27a of the multilayer body 12B so as to be exposed at the fourth surface 12d.

Each of the first dummy electrodes 25a and an associated one of the second internal electrodes 16b are preferably provided on the same or substantially the same plane, and have the same or substantially the same thickness. Each of the second dummy electrodes 25b and an associated one of the first internal electrodes 16a are preferably provided on the same or substantially the same plane, and have the same or substantially the same thickness.

The first dummy electrodes 25a and the second dummy electrodes 25b may also be provided in the first surface-side outer layer portion 20a and the second surface-side outer layer portion 20b. In this case, it is preferable that the first dummy electrodes 25a and the second dummy electrodes 25b are provided in a portion corresponding to a position where the end portions (L gaps) 27a and 27b are moved in parallel or substantially in parallel in the lamination direction x. With this configuration, in a case in which the plated layer is provided without providing the base electrode layer 32, it is possible to easily provide the plated layer.

Further, in a case in which the first dummy electrodes 25a and the second internal electrodes 16b are provided on the same or substantially same plane, it is possible to provide the first dummy electrodes 25a and the second internal electrodes 16b on the same or substantially the same plane by printing the first dummy electrodes 25a together with the second internal electrodes 16b when the second internal electrodes 16b are printed. Further, in a case in which the second dummy electrodes 25b and the first internal electrodes 16a are provided on the same or substantially the same plane, it is possible to print the second dummy electrodes 25b together with the first internal electrodes 16a when the first internal electrodes 16a are printed.

With the multilayer ceramic capacitor 10B according to the modified example 2 shown in FIG. 9, it is possible to achieve the same or substantially the same advantageous effects as those of the multilayer ceramic capacitor 10 of FIG. 1.

### (3) Modified Example 3

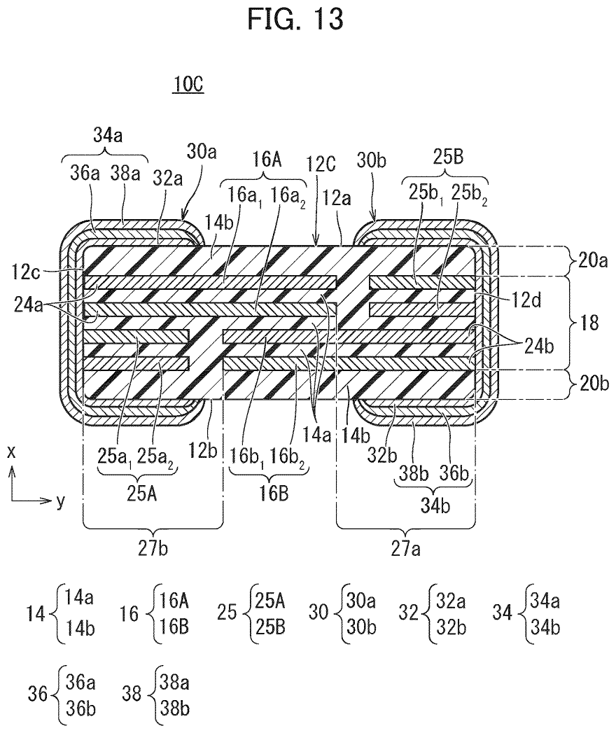

Next, an example of a multilayer ceramic capacitor 10C according to modified example 3 of an example embodiment of the present invention will be described. FIG. 13 is a cross-sectional view showing the modified example 3 of an example embodiment of the present invention in the cross-sectional view shown in FIG. 10. However, the same or corresponding configurations as those in FIGS. 1 to 4 are denoted by the same reference numerals, and detailed descriptions thereof are omitted.

The multilayer body 12C of the multilayer ceramic capacitor 10C according to the third modified example of the present example embodiment includes, as the internal electrodes 16, a pair of first internal electrodes 16A and a pair of second internal electrodes 16B, as shown in FIG. 13.

The pair of first internal electrodes 16A includes two first internal electrodes 16a₁ and 16a₂ that are continuously adjacent to each other in the lamination direction x. The pair of first internal electrodes 16A is electrically connected to the first external electrode 30a. The pair of second internal electrodes 16B includes two second internal electrodes 16b₁ and 16b₂ that are continuously adjacent to each other in the lamination direction x. The pair of second internal electrodes 16B is electrically connected to the second external electrode 30b.

In the end portion (L gap) 27b of the multilayer body 12C, a pair of first dummy electrodes 25A is provided so as to be exposed at the third surface 12c. In the end portion (L gap) 27a of the multilayer body 12C, a pair of second dummy electrodes 25B is provided so as to be exposed at the fourth surface 12d.

The pair of first dummy electrodes 25A includes two first dummy electrodes 25a₁ and 25a₂ that are continuously adjacent to each other in the lamination direction x. Each of the first dummy electrodes 25a₁ and 25a₂ of the pair of first dummy electrodes 25A and an associated one of the second internal electrodes 16b₁ and 16b₂ of the pair of second internal electrodes 16B are preferably provided on the same or substantially the same plane, and have the same or substantially the same thickness. The pair of second dummy electrodes 25B includes two second dummy electrodes 25b₁ and 25b₂ that are continuously adjacent to each other in the lamination direction x. Each of the second dummy electrodes 25b₁ and 25b₂ of the pair of second dummy electrodes 25B and an associated one of the first internal electrodes 16a₁ and 16a₂ that constitute the pair of first internal electrodes 16A are preferably provided on the same or substantially the same plane, and have the same or substantially the same thickness.

The multilayer ceramic capacitor 10C according to the third modified example shown in FIG. 13 provides the same or substantially the same advantageous effects as the multilayer ceramic capacitor 10 shown in FIG. 1.

### 3. Manufacturing Method of Multilayer Ceramic Capacitor

Next, an example of a manufacturing method of the multilayer ceramic capacitor according to an example embodiment of the present invention will be described.

### Step of Preparing Ceramic Green Sheets

First, ceramic green sheets for manufacturing dielectric layers and electrically conductive paste for manufacturing internal electrodes are prepared. The ceramic green sheets and the electrically conductive paste for manufacturing internal electrodes include a binder and an organic solvent. The binder and the organic solvent may be known ones.

At this time, the ceramic green sheets for manufacturing the inner dielectric layer regions are formed, for example, by a dielectric paste including CaZrO₃ including Li. More specifically, this dielectric paste includes, as main components, at least Ca, Sr or Zr, and Li. For example, the dielectric paste includes CaZrO₃ or SrZrO₃ as dielectric components and includes Li as a sintering aid. In addition to these, the dielectric paste may include, for example, Mn, Ti, or the like.

The dielectric paste for forming the ceramic green sheets for manufacturing the inner dielectric layer regions, when CaZrO₃ is used as the main component, includes a glass component added to CaZrO₃ in an amount of, for example, about 2 wt % or more and about 4 wt % or less. At this time, the amount of Li included in the glass component may be, for example, about 3 wt % or more and about 4 wt %.

Then, the electrically conductive paste for manufacturing internal electrodes is printed on the ceramic green sheets for manufacturing the inner dielectric layer regions in a predetermined pattern by, for example, screen printing or gravure printing. Ceramic green sheets having patterns of the first internal electrodes formed thereon and ceramic green sheets having patterns of the second internal electrodes formed thereon are thereby prepared.

### Step of Obtaining Multilayer Sheet

Subsequently, a predetermined number of ceramic green sheets for manufacturing the outer layers on which no internal electrode pattern is printed are laminated to form a portion that defines and functions as the second surface-side outer layer portion adjacent to the second surface. Then, the ceramic green sheets on which the first internal electrode pattern is printed and the ceramic green sheets on which the second internal electrode pattern is printed are sequentially laminated on the portion that defines and functions as the second surface-side outer layer portion so as to have the configuration of an example embodiment of the present invention, thus forming a portion that defines and functions as the inner layer portion. On the portion that defines and functions as the inner layer portion, a predetermined number of ceramic green sheets for manufacturing the outer layers on which no internal electrode pattern is printed are laminated to form a portion that functions as a first surface-side outer layer portion adjacent to the first surface. Thus, a multilayer sheet is produced.

### Step of Obtaining Multilayer Block

Next, the multilayer sheet is pressed in the lamination direction by, for example, hydrostatic pressing to produce a multilayer block.

### Step of Obtaining Multilayer Chip

Then, the multilayer block is cut into a predetermined size to cut out multilayer chips.

### Step of Obtaining Fired Chip

Next, the multilayer chips are fired to produce fired chips. Specifically, for example, after heating at about 200° C. or more and about 300° C. or less, firing is performed in a non-oxidizing atmosphere at a temperature rising rate of about 3.33° C./min or more and about 200° C./min or less and a maximum firing temperature of about 900° C. or more and about 1040° C. or less to form fired chips.

Next, an electrically for a base electrode layer including a metal component and a glass component is prepared.

### Step of Forming External Electrode

The prepared electrically conductive paste that defines and functions as a base electrode layer is applied to surfaces corresponding to the third surface and the fourth surface of the fired chips to form base electrode layers. For application of the electrically conductive paste to the surfaces corresponding to the third surface and the fourth surface of the fired chips, for example, a method such as dipping is used. For example, the electrically conductive paste that defines and functions as the base electrode layer may include Cu as a main component as the metal component and include a glass component in a content of about 10 vol % or more and about 20 vol % or less. At this time, for example, for Cu particles, those having a flat shape have D50 of about 2 μm or more and about 4 μm or less, respectively, and those having a spherical shape have D50 of about 0.3 μm or more and about 0.5 μm or less are used.

Subsequently, the fired chips to which the electrically conductive paste is applied are fired to form fired chips with the base electrode layers. At this time, it is preferable to adjust the firing conditions so that an appropriate amount of Li is included in the base electrode layers after firing the electrically conductive paste. When firing is performed under conditions such that Li is not included in the base electrode layers, densification of the base electrode layers is not promoted, and there is a risk that many defects may occur in high-temperature load tests, such as infiltration of plating solution in the plating step described later and opening of the interface between the internal electrodes and the inner dielectric layers. Furthermore, when segregation of Li scattered into the base electrode layers is large or when the amount of Li is too large, the proportion of the glass component increases, and moisture resistance may deteriorate. The firing conditions for the fired chips may be, for example, firing in a reducing atmosphere at about 850° C. or more and about 900° C. or less for about 0.3 hours or more and about 0.5 hours or less.

In addition, a capacitor in which the W dimension of the multilayer ceramic capacitor 10 is larger than the L dimension as in the present example embodiment has a large contact surface between the multilayer body 12 and the external electrodes 30. Therefore, lithium in the multilayer body 12 is more likely to scatter into the external electrodes 30 during the external electrode firing step. Therefore, the paste for use in forming the external electrodes 30 and the firing atmosphere for forming the external electrodes are set to appropriate ranges.

Next, if necessary, plating is conducted on the surface of the base electrode layers to form plated layers. In the present example embodiment, two plated layers are formed on the surfaces of the base electrode layers. Specifically, for example, a Ni plated layer and a Sn plated layer are formed on the base electrode layers. As the plating process, it is preferable to use electrolytic plating. The Ni plated layer and the Sn plated layer are sequentially formed by, for example, barrel plating.

As described above, the multilayer ceramic capacitor 10 according to the present example embodiment is manufactured.

### 3. Experimental Example

Next, in order to confirm the advantageous effects of the multilayer ceramic capacitors according to example embodiments of the present invention described above, multilayer ceramic capacitors with varying sizes of Li segregation included in the base electrode layers were manufactured as experimental samples according to the manufacturing method described above, and moisture resistance tests and high-temperature load reliability tests were conducted.

### (1) Specifications of Multilayer Ceramic Capacitors Manufactured as Samples of the Experimental Examples

Multilayer ceramic capacitors of Sample Nos. 1 to 7 were manufactured using the manufacturing method according to the above-described example embodiment.
Structure of multilayer ceramic capacitor: multilayer ceramic capacitor shown in FIG. 1
Dimension of multilayer ceramic capacitor in first direction: about 300 μm
Dimension of multilayer ceramic capacitor in second direction: about 600 μm
Dimension of multilayer ceramic capacitor in lamination direction: about 200 μm
Main component of internal electrode: Cu
Main component of inner dielectric layer: CaZrO₃
Main component of base electrode layer: Cu
Thickness of base electrode layer located at about ½ of W dimension in second direction z of multilayer ceramic capacitor and in the middle in lamination direction x: about 20 μm
Plated layer

### Two-Layer Formation of Ni Plated Layer and Sn Plated Layer

Ni plated layer thickness: approximately about 3 μm
Sn plated layer thickness: approximately about 5 μm

### (2) Measurement Method of Li Segregation Size

The size of the Li segregation in the base electrode layer was defined by the presence of Li when the base electrode layer located in the middle in the lamination direction x was observed using TOF.SIMS under conditions of about 30 μm with the interface between the multilayer body and base electrode layer as the center of the observed image, in a cross section in the lamination direction x×the first direction y when each sample multilayer ceramic capacitor was polished to about ½ of the W dimension in the second direction z. The measurement conditions by TOF.SIMS were as follows:
Equipment name: TOF.SIMS (available from ION-TOF)
Primary ion: Bit
Acceleration voltage: about 25 kV
Secondary ion polarity: Positive
Number of scans: 32
Number of pixels: 256 pixels×256 pixels
Measurement area: about 30 μm×about 30 μm

For the size of Li segregation, those with an area of about 0.5 μm² or more were counted. For example, when there were three Li segregated locations, the Li segregated location having the largest size among them was identified, and that Li segregated location was defined as the Li size.

### (3) Moisture Resistance Test Method

First, the multilayer ceramic capacitors of each sample were mounted on a wiring substrate using solder, and the insulation resistance values were measured. At this time, the multilayer ceramic capacitors of each sample mounted on the wiring substrate were placed in a high-temperature high-humidity chamber, and a moisture resistance test was conducted by maintaining them for about 2000 hours in an environment of about 85° C. and about 85% RH relative humidity with about 200 V DC current applied to the external electrodes of the multilayer ceramic capacitors of each sample. Then, the insulation resistance values of the multilayer ceramic capacitors of each sample after this moisture resistance test were measured. Cases where the insulation resistance value after the moisture resistance test decreased by one digit or more from the insulation resistance value before the moisture resistance test were considered NG (defective). The number of multilayer ceramic capacitors for each sample was 100.

### (4) High-Temperature Load Reliability Test

First, the multilayer ceramic capacitors of each sample were mounted on a wiring substrate using solder, and the insulation resistance values were measured. At this time, the multilayer ceramic capacitors of each sample mounted on the wiring substrate were placed in a chamber, and a high-temperature load test was conducted by maintaining them for about 2000 hours in an environment of about 150° C. with about 200 V DC current applied to the external electrodes of the multilayer ceramic capacitors of each sample. Then, the insulation resistance values of the multilayer ceramic capacitors of each sample after this high-temperature load test were measured. Cases where the insulation resistance value after the high-temperature load test decreased by one digit or more from the insulation resistance value before the high-temperature load test were considered NG (defective). The number of multilayer ceramic capacitors for each sample was 100.

### (5) Results

Table 1 shows the results of moisture resistance tests and high-temperature load reliability tests when the size of Li segregation included in the base electrode layer was varied in the multilayer ceramic capacitors of each sample from Sample Nos. 1 to 7.

Sample No. 7 did not include Li in the base electrode layer, but included Li in the multilayer body. On the other hand, Sample Nos. 1 to 6 included Li in both of the base electrode layer and the multilayer body, but the size of Li segregation in the base electrode layer was larger than the size of Li segregation included in the multilayer body.

TABLE 1

| Sample No. | 1 | 2 | 3 | 4 | 5 | 6 | 7 |
|---|---|---|---|---|---|---|---|
| Size of Li Segregation (μm²) | 0.06 | 1.00 | 3.50 | 18.50 | 30.20 | 44.50 | — |
| Moisture Resistance Test | 0/100 | 0/100 | 0/100 | 1/100 | 2/100 | 4/100 | 0/100 |
| High-temperature Load Reliability Test | 8/100 | 4/100 | 1/100 | 0/100 | 0/100 | 0/100 | 10/100 |

According to Table 1, the size of Li segregation included in the base electrode layer increases from Sample No. 1 to Sample No. 6. Therefore, from Sample No. 1 to Sample No. 6, the difference between the size of Li segregation included in the multilayer body and the size of Li segregation included in the base electrode layer increases. As a result, it was confirmed that as the size of Li segregation included in the base electrode layer increased, the number of samples that resulted in NG (defective) in the high-temperature load test decreased. On the other hand, in the sample of Sample No. 7, since there was no Li segregation in the base electrode layer, the number of samples that resulted in NG (defective) in the high-temperature load test was relatively high at 10 out of 100.

When the sizes of Li segregation in the samples of Sample Nos. 1 to 3 were used, no samples resulted in NG (defective) in the moisture resistance test, and good results were obtained. On the other hand, when the sizes of Li segregation in the samples of Sample Nos. 4 to 6 were used, although few in number, there were samples that resulted in NG (defective) in the moisture resistance test.

From the above results, it is confirmed in example embodiments of the present invention that as the size of Li segregation included in the base electrode layer is larger, the results of the high-temperature load reliability test are better. It is also confirmed that, when the size of Li segregation is in the range of about 1.0 μm² or more and about 30.2 μm² or less, the results of the moisture resistance test are also relatively good.

As described above, although example embodiments of the present invention are disclosed in the above description, the present invention is not limited thereto.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a first surface and a second surface opposed to each other in a lamination direction, a third surface and a fourth surface opposed to each other in a first direction orthogonal or substantially orthogonal to the lamination direction, and a fifth surface and a sixth surface opposed to each other in a second direction orthogonal or substantially orthogonal to the lamination direction and the first direction;
a first external electrode on the third surface of the multilayer body; and
a second external electrode on the fourth surface of the multilayer body; wherein
a dimension of the multilayer body in the first direction is shorter than a dimension of the multilayer body in the second direction,
the multilayer body includes a plurality of first internal electrodes each including one end exposed on the third surface, a plurality of second internal electrodes each including one end exposed on the fourth surface, and a plurality of inner dielectric layers each with a corresponding one of the plurality of first internal electrodes or a corresponding one of the plurality of second internal electrodes provided thereon;
the plurality of inner dielectric layers each include at least Ca, Sr or Zr, and Li as main components; and
in at least one of a region of about 30 μm centered on a dimension of about ½ in the lamination direction and an interface between the multilayer body and the first external electrode or a region of about 30 μm centered on a dimension of about ½ in the lamination direction and an interface between the multilayer body and the second external electrode, Li segregation exists in at least one of the first external electrode or the second external electrode, and a size of the Li segregation in the at least one of the first external electrode or the second external electrode is larger than a size of Li segregation in the plurality of inner dielectric layers.

2. The multilayer ceramic capacitor according to claim 1, wherein the size of the Li segregation in at least one of the first external electrode or the second external electrode is about 1.0 μm² or more and about 30.2 μm² or less.

3. The multilayer ceramic capacitor according to claim 1, wherein each of the plurality of inner dielectric layers includes CaZrO₃ or SrZrO₃ as a dielectric component and Li as a sintering aid.

4. The multilayer ceramic capacitor according to claim 1, wherein each of the plurality of first and second internal electrodes include Cu as a main component.

5. The multilayer ceramic capacitor according to claim 1, wherein a thickness of each of the plurality of first and second internal electrodes is about 0.5 μm or more and about 3.5 μm or less.

6. The multilayer ceramic capacitor according to claim 1, wherein each of the first and second external electrodes includes a base electrode layer and a plated layer on the base electrode layer.

7. The multilayer ceramic capacitor according to claim 6, wherein each of the base electrode layers includes a metal component and a glass component.

8. The multilayer ceramic capacitor according to claim 7, wherein the metal component includes Cu as a main component.

9. The multilayer ceramic capacitor according to claim 7, wherein the glass component includes Na, B, Si, Zn, or Ba.

10. The multilayer ceramic capacitor according to claim 8, wherein a particle size of Cu particles of the Cu included in the base electrode layers is about 1.5 μm or more and about 3.5 μm or less.

11. The multilayer ceramic capacitor according to claim 6, wherein each of the plated layers includes Cu, Ni, Sn, Ag, Pd, Ag—Pd alloy, or Au.

12. The multilayer ceramic capacitor according to claim 6, wherein each of the plated layers includes a lower plated layer and an upper plated layer on the lower plated layer.

13. The multilayer ceramic capacitor according to claim 12, wherein the lower plated layer includes Ni and the upper plated layer includes Sn.

14. The multilayer ceramic capacitor according to claim 12, wherein a thickness of each of the lower plated layer and the upper plated layer is about 1.0 μm or more and about 15.0 μm or less.

15. The multilayer ceramic capacitor according to claim 1, further comprising:
first dummy electrodes exposed at the third surface; and
second dummy electrodes exposed at the fourth surface; wherein
each of the first dummy electrodes is on a same or substantially a same plane as the plurality of second internal electrodes; and
each of the second dummy electrodes is on a same or substantially a same plane as the plurality of first internal electrodes.

16. The multilayer ceramic capacitor according to claim 15, wherein
each of the first dummy electrodes has a same or substantially a same thickness as the plurality of second internal electrodes; and
each of the second dummy electrodes has a same or substantially a same thickness as the plurality of first internal electrodes.
